(19) United States
(12) Patent Application Publication
(10) Pub. No.: US 2009/0241075 A1
(43) Pub. Date: Sep. 24, 2009

(54) TEST CHIP VALIDATION AND DEVELOPMENT SYSTEM

(76) Inventors: Shahriar Ahmed, Portland, OR (US); Kedar Dongre, Hillsboro, OR (US); Jeffrey C. Hunter, Forest Grove, OR (US); Rott Pavel, Portland, OR (US); Vincent Rayappa, Hillsboro, OR (US); Joseph Yip, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/053,852

(22) Filed: Mar. 24, 2008

(51) Int. Cl. G06F 17/50

(52) U.S. Cl. 716/4; 716/11

(57) ABSTRACT

Embodiments of an IC design system for test row/structure layout design are described in this application. The design system may include a test chip complier database, a test chip complier engine (TCCE), and a user interface module. The TCCE may be configured to communicate with at least the test chip compiler database and the user interface module, and configured to allow a user to automatically generate a test chip layout by providing an integrated circuit design system. With the system, a user can automatically generate a design by specifying the test row or test structure layout requirements for the design using sets of predefined templates, changing design template parameters using a table driven input format, scheduling generation of the design on a preferred layout design tool, visually inspecting the generated design for errors, and/or applying version controls to the generated design. Other embodiments are described.

### FIELD

This application relates generally to circuit design and manufacturing. In particular, this application relates to tools for improving efficiency and automation in circuit design and manufacturing, particularly integrated circuit (IC) chip design and manufacturing.

### BACKGROUND

Conventional test row/test structure layout design for ICs is inefficient and time-consuming, and is essentially a manual activity with the device engineers and mask designer working together to coordinate design drawings generation and validation, (FIG. 4). The device engineer determines the specifications of the test structure by textual description, some illustrative diagrams, and exact dimensions for various aspects of the test structures. The device engineer then forwards the design specifications to the assigned mask designer, who manually draws the test structures and test pads in a layout design tool, which is then examined by the device engineer and returned for corrections and revisions. Once the corrections are completed and approved by the device engineer, the mask designer manually locks and “version controls” the design file and moves it to a tapeout assembly area. After the layout generation, the device engineer is responsible to document the design, specifically tabulate the key structure dimensions and design rules parameter values, and ensure that the test structures are connected to the pads. The design information is documented in catalog files, which are manually collated and the E-Test Test package/program is generated based on the catalog files. Due to the static/disconnected nature of the catalog documents there is frequent need to manually examine the drawings and update the test package accordingly. Additionally, current processes have limited extensibility with little or no support for plug-n-play or integration with other components.

### BRIEF DESCRIPTION OF THE DRAWINGS

The following description can be better understood in light of Figures, in which:

FIG. 1 illustrates a schematic of an exemplary circuit design system;

FIG. 2 illustrates a schematic of an exemplary circuit design system; and

FIG. 3 illustrates empirical data improvements using an exemplary circuit design system.

Together with the following description, the Figures demonstrate and explain the principles of the apparatus and methods described herein. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any apparatus and techniques conventionally used in the industry.

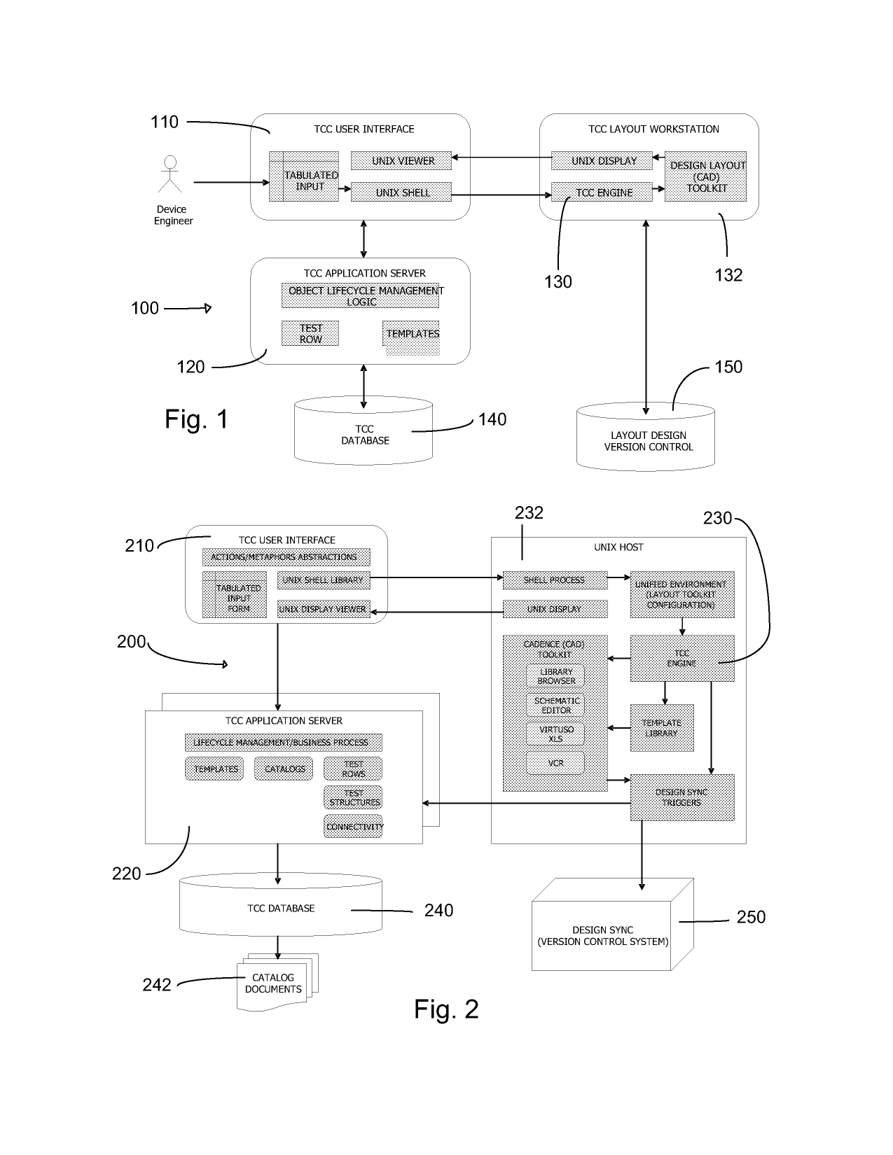

FIG. 1 illustrates test chip compiler (TCC) integrated circuit design system (TCC system) 100. TCC design system 100 may include TCC application server 120, test chip compiler engine module (TCCE) 130, TCC user interface module 110, TCC layout module 132, TCC database 140, and version control module 150. TCC layout module 120 may include a driver for layout design tools, such as a CAD module, and connection to version control module 150. TCC user interface module 110 may include abstraction to manipulate design templates and control design execution. TCC database 140 may be a layout parameters storage facility. Version control module 150 may also include a layout design module.

TCC system 100 may provide several capabilities to device engineers, such as the capability to specify the test row, test structure layout requirements using sets of predefined templates, change design templates parameters (e.g. their location, orientation, dimension) using a table driven input format, schedule design generation on preferred layout design tool, visually inspect generated design for errors, repeat design loop (add/remove templates, edit templates parameters, generate, inspect) as required, and apply version controls to the generated design.

Using TCC system 100 to design a layout may be accomplished in several ways, for example, for a given layout tool, requirements for reusable components stored in a design library in TCC database 140 or version control module 150 may be defined. The reusable components may be described in a convenient format in application server and made available through TCC user interface module 110 to a user to use in design definition. Design definition may consist of specification of design destination (usually, design library), auxiliary design features (silicon labels, pad location, possible bus wire configuration), set of components with their attributes. Then information about the design may then be stored in a dedicated storage facility, such as TCC database 140 or version control module 150, and TCC user interface module 110 interacts with TCCE 130 to start design generation.

Upon completion of the design generation, a user may be provided with visual representation of the design to allow for error inspection. TCC system 100 may allow a user to repeat any design step, allowing the user to change component and general design attributes. When the design is done, the user can interact through TCC user interface module 110 with version control tools in version control module 150 to apply revision controls to the design. The stored design configuration may then be used in TCC user interface module 110 to reflect the status of components in the generated design.

TCC user interface module 110 may abstract the underlying complexity of a layout toolkit and present intuitive usability metaphors to input design specifications. TCC user interface module 110 may allow the user to generate, view, and validate the design, and view documentation, using graphical user interface tools (GUI), such as drag-n-drop, table driven input, menu options, button clicks, object explorer, etc. TCC user interface module 110 may also present an integrated solution to a user by providing a shell library and display viewer components, which allows communication between TCCE 130, TCC application server 120, and TCC layout module 132, displaying any results corresponding to a user action. TCC layout module 132 may include a UNIX display driver to generate views for TCC user interface 1 10.

TCCE 130 integrates with the design layout toolkit in TCC layout module 132 and the template library, thus automating procedural steps of design (workspace preparation, structure placement, hierarchy manipulation) based on the user inputs in the user interface. In addition based on the user actions the TCCE 130 also interfaces with version control system to enable check-in/check-out of completed design into and from version control system. As part of design check-in/check-out TCCE 130 also updates TCC application server 120 with the current test structure parameter values and the test row states—thus ensuring that data in TCC database 140 is synchronized with the layout.

The device engineer, as a part of test row generation activity, may browse the template collection, which may be located in TCC application server 120 or in TCC layout module 132, in TCC user interface 110 and select the most appropriate templates for a desired design. The device engineer may then specify the structure dimensions and design rule parameters using the table driven input form. The engineer may now select the “generate test row” action in the user interface which triggers TCC user interface 110 to establish communication with TCCE 130 and communicate the user specifications. TCCE 130 may then leverage the template library and layout design toolkit automation functionality to generate the design and display it on the UNIX display process. The user can now review the generated design in the integrated display viewer through TCC user interface 110.

The user can also check-in the design by selecting the “check-in design menu” which again triggers TCC user interface 110 to communicate with TCCE 130 to service the request. TCCE 130 may then communicate with the version control module 150 to check-in the design files and part of this activity updates the application server with the updated parameter information. TCC application module 120 may then load the updated information to TCC database 140. The user can now view the updated information in TCC user interface 110. This sequence of actions can be repeated multiple times (refining the structure parameters and description) with TCC user interface 110 controlling the different actions allowed on the test row design based on the test row state and the defined business process. Once the test row is ready for tapeout, the catalog information can be exported from TCC database 140 for E-Test package/program generation.

In conventional design processes, manual reuse of components is discouraged because it is an error-prone and effort intensive task. TCC system 100 allows for separation of component manipulation from actual design tools, creating a clear advantage during design regeneration. Also storing and analyzing information regarding design components makes live design documentation possible.

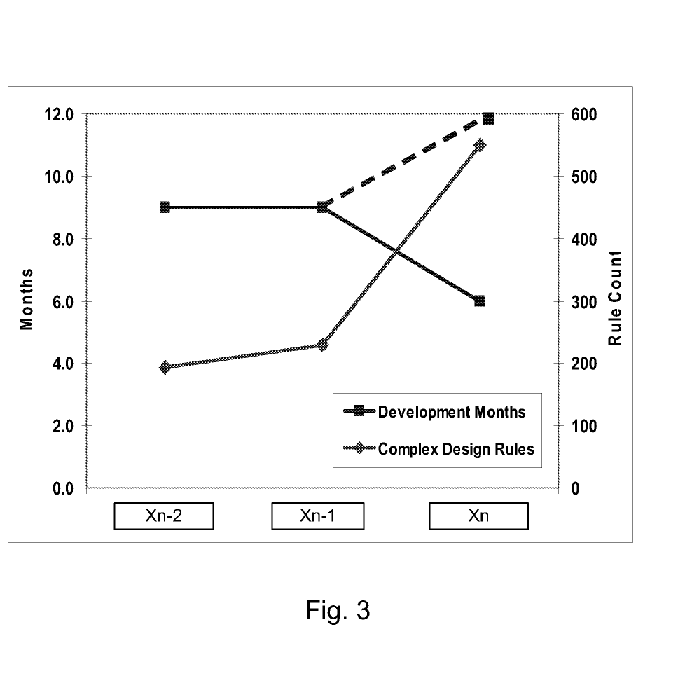

Each of the modules and components of TCC system 100 may be physically ordered in any number of configurations using any number of computer hosts, networks, workstations, etc. For example, FIG. 2 illustrates an embodiment of TCC system 200 that may include additional components in different configurations. TCC application server 220 may include rules and configurations for templates, catalogs, test rows, test structures, connectivity, lifescycle management/business process, etc. Unix host 332 may house the shell process, unix display, layout toolkit configuration, TCCE 230, CAD toolkit, template library, design sync triggers, etc. TCC user interface 210 may include actions/metaphors abstractions, tabulated input form, Unix shell library, Unix display viewer, etc. Catalog documents 242 may be associated with or stored in TCC database 240, to be accessed when needed. Similarly, design sync, also version control system, 150 may be a separate component connected to any other component, or may be resident to Unix host 232.

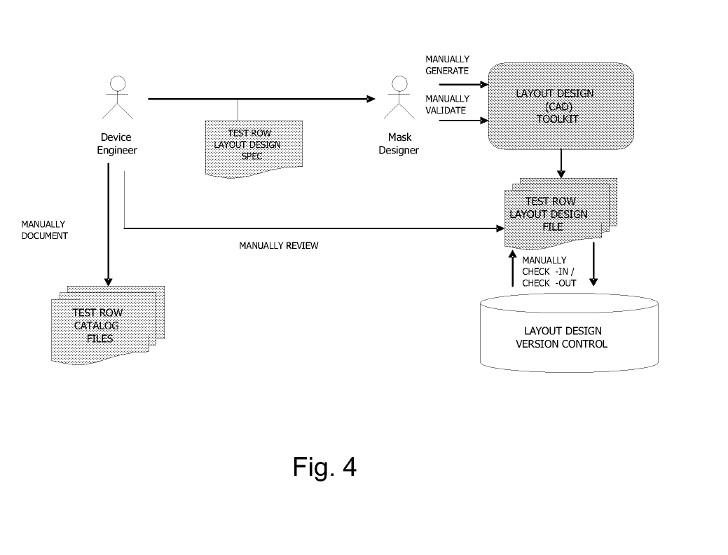

In an empirical test of TCC system 100, as illustrated in FIG. 3, Xn represents a chip design produced using an embodiment of TCC system 100, 200. Xn-1 and Xn-2 represent chip designs produced using a conventional chip design process, as shown in FIG. 4. As shown in the graph, the time to develop Xn was reduced from an estimated 12 months to 6 months, and reduced from the 9 months required to develop both Xn-1 and Xn-2. In addition to reducing the development time, the number of rules, representing the complexity of a design, more than doubled, meaning that Xn development was far more efficient than development of Xn-1 and Xn-2.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. A system, comprising:
a test chip complier database;
a test chip complier application module; and
a user interface module, wherein at least the test chip compiler application module is configured to communicate with at least the test chip compiler database and the user interface module, and configured to allow a user to automatically generate a test chip layout.

2. The system of claim 1, further comprising a version control module, wherein the version control module includes a layout design module, wherein the version control module is configured to automate a plurality of procedural design steps, and wherein the plurality of procedural design steps are selected from workspace preparation, structure placement, and hierarchy manipulation.

3. The system of claim 2, wherein the version control module is configured to enable placement and withdrawal of the completed test chip layout within the version control module.

4. The system of claim 1, wherein the user interface module is configured to standardize control of layout design parameters.

5. The system of claim 1, wherein the user interface module is configured to interface with the test chip controller database to store design information.

6. The system of claim 1, wherein the test chip layout is validated for design correctness and compatibility to process design rules.

7. The system of claim 1, further comprising a CAD module.

8. The system of claim 1, wherein the test chip compiler application module includes one or more of a lifecycle management module, a templates module, a catalogs module, a test rows module, a test structures module, or a connectivity module.

9. The system of claim 1, wherein the test chip compiler application module is configured to automatically adjust a test chip layout to correct for connectivity errors in response to a user change to the test chip layout.

10. The system of claim 1, wherein the system is configured to allow a user to perform at least one of:
specify the test row or test structure layout requirements using sets of predefined templates;
change design template parameters using a table driven input format;
schedule design generation on a preferred layout design tool;
visually inspect the test chip layout for errors; or
apply version controls to the test chip layout.

11. An method, comprising:
providing an integrated circuit design system, wherein the system includes a computer, a test chip compiler engine, a test chip compiler user interface; and a test chip compiler database;
generating a design; and
using the system to perform at least one of,
specify the test row or test structure layout requirements for the design using sets of predefined templates;
change design template parameters using a table driven input format;
schedule generation of the design on a preferred layout design tool;
visually inspect the generated design for errors; or
apply version controls to the generated design.

12. The method of claim 11, wherein the system is configured to perform the generating a design.

13. The method of claim 11, wherein the system further includes a CAD module.

14. The method of claim 11, wherein the system further includes a version control module.

15. The method of claim 11, wherein the test chip compiler database includes a test structure template library.
